(19) United States
(12) Patent Application Publication
(10) Pub. No.: US 2026/0145669 A1
(43) Pub. Date: May 28, 2026

(54) DRIVING SUPPORT APPARATUS, DRIVING SUPPORT METHOD, AND NON-TRANSITORY STORAGE MEDIUM STORING PROGRAM THEREOF

(71) Applicant: TOYOTA JIDOSHA KABUSHIKI KAISHA, Toyota-shi (JP)

(72) Inventors: Yutaro Matsuura, Toyota-shi (JP); Kazuya Okamoto, Toyota-shi (JP)

(73) Assignee: TOYOTA JIDOSHA KABUSHIKI KAISHA, Toyota-shi (JP)

(21) Appl. No.: 19/384,150

(22) Filed: Nov. 10, 2025

(30) Foreign Application Priority Data
Nov. 27, 2024 (JP) 2024-206682

(51) Int. Cl. B60W 30/09; B60W 30/095; B60W 50/00; G06V 20/56

(52) U.S. Cl. CPC B60W 30/09; B60W 30/0956; B60W 50/00; G06V 20/56; B60W 2050/0073; B60W 2420/403; B60W 2540/18; B60W 2552/15

(57) ABSTRACT

A driving support apparatus executes a collision avoidance operation to prevent a collision between a vehicle and an object when a collision determination condition, defined to be satisfied when there is a high likelihood of collision, is satisfied. The apparatus inhibits the collision avoidance operation even if the collision determination condition is satisfied when a steering override condition, defined to be satisfied when a driver performs a predetermined steering operation, is satisfied, and changes the steering override condition to a condition less likely to be satisfied when a specific condition, including when the vehicle is located in a parking lot having a plurality of slopes requiring turning travel, is satisfied.

### TECHNICAL FIELD

The present disclosure relates to a driving support apparatus, a driving support method, and a non-transitory computer-readable storage medium storing a program thereof, for performing an operation to reduce the likelihood that a vehicle will come into contact with an object when the vehicle travels through a specific parking lot (e.g., a multi-story parking lot) having a plurality of slopes each requiring the vehicle to make a predetermined turning travel (i.e., a predetermined turning movement performed by the vehicle) to pass through.

### BACKGROUND

A conventional driving support apparatus (hereinafter, simply referred to as a “conventional apparatus”) activates an automatic braking when the apparatus determines that a vehicle is highly likely to collide with an object.

Furthermore, even when the conventional apparatus determines that the vehicle is highly likely to collide with the object, it does not perform the automatic braking in order to prioritize a collision avoidance operation by a driver, if a steering index value relating to a steering operation by the driver satisfies a steering override condition (refer to Japanese Patent Application Laid-Open No. 2021-79904).

### SUMMARY

As shown in FIG. 2, in a multi-story parking lot, a certain floor is connected to a floor above or below it by a slope SL having a large curvature. Hereinafter, this slope SL is referred to as a “parking-lot slope SL”. When a driver drives the vehicle HV through/on the parking-lot slope SL, he/she steers a steering wheel significantly. This steering operation may often satisfy the above-described steering override condition. Therefore, when the vehicle HV passes through the parking-lot slope SL, the automatic braking is often inhibited. As a result, the vehicle HV may come into contact with not only a preceding vehicle but also “a side wall, a fence, or a similar structure” of the parking-lot slope SL.

The present disclosure is made to cope with the problem described above. One of the objects of the present disclosure is to provide a driving support apparatus, a driving support method, and a non-transitory storage medium storing a program thereof, capable of reducing the likelihood that a vehicle will come into contact with an object when the vehicle travels through a slope that requires the vehicle to make a predetermined turn (e.g., the parking-lot slope SL in the multi-story parking lot). Hereinafter, “step” is expressed as “S”.

An embodiment of a driving support apparatus according to the present disclosure comprises a controller (10) configured to:
execute a collision avoidance operation to prevent a collision between a vehicle (HV) and an object when a collision determination condition (S370), which is defined to be satisfied when there is a high likelihood that the vehicle will collide with the object, is met (S360: Yes); and
not execute (i.e., inhibit) the collision avoidance operation (S380) even when the collision determination condition is met (S360: Yes), if a steering override condition, which is defined to be satisfied when a driver of the vehicle performs a predetermined steering operation, is met (S365: Yes).

Furthermore, the controller is configured to switch the steering override condition to a condition that is harder to be satisfied (S335, S350, and S355) when a specific condition is satisfied (S310, S320) than (i.e., as compared to) when the specific condition is not satisfied. The specific condition includes a condition defined to be satisfied when the vehicle is located in a specific parking lot having a plurality of slopes (SL) each requiring a predetermined turning travel to pass through.

According to the above embodiment, the steering override condition is switched to a condition that is harder to be satisfied (i.e., less likely to be satisfied) when the vehicle is located in the specific parking lot having a plurality of slopes each requiring a predetermined turning travel to pass through. Accordingly, the steering override condition is less likely to be satisfied even when a driver makes a large and/or rapid steering operation while the vehicle is traveling on the slope in the specific parking lot. Therefore, the collision avoidance operation is likely to be executed when the collision avoidance determination is satisfied. Consequently, the likelihood that a vehicle will collide with an object can be reduced.

Notably, in the above description, in order to facilitate understanding of the present disclosure, the constituent elements corresponding to those of embodiments which will be described later are accompanied by parenthesized numerals and/or names which are used in the embodiments; however, the constituent elements of the present disclosure are not limited to those in the embodiments identified by the reference numerals and/or names. The present disclosure encompasses a driving support method, and a non-transitory storage medium storing a program thereof.

### BRIEF DESCRIPTION OF THE DRAWINGS

FIG. 1 is a schematic diagram of a driving support apparatus according to an embodiment of the present disclosure.

FIG. 2 is a plan view of a multi-story parking lot and a parking-lot slope.

FIG. 3 is a routine executed by a CPU of a driving support ECU shown in FIG. 1.

FIG. 4 is another routine executed by a CPU of a driving support ECU shown in FIG. 1.

### DETAILED DESCRIPTION

### Configuration

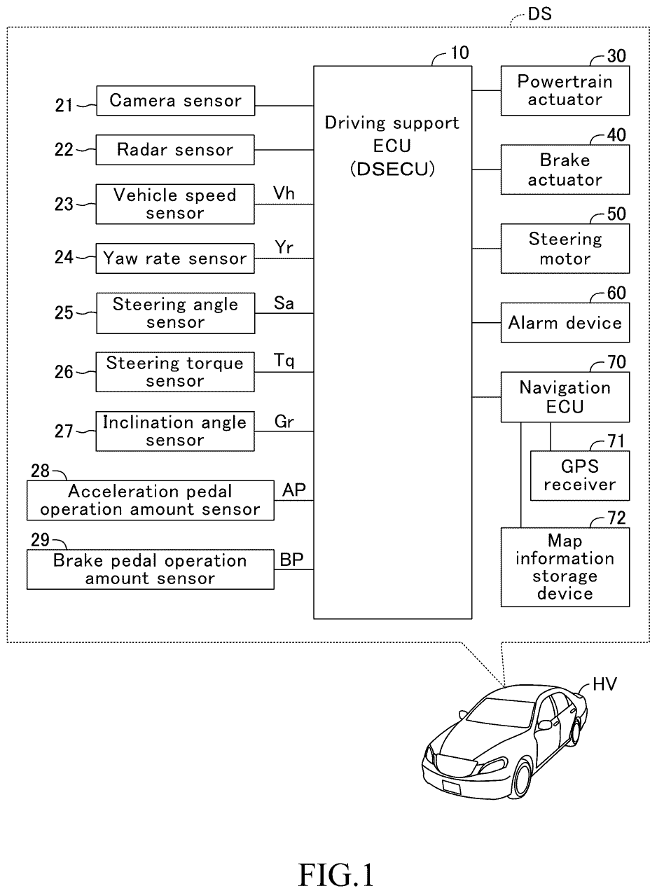

A driving support apparatus (hereinafter, referred to as “apparatus DS”) according to an embodiment of the present disclosure comprises components shown in FIG. 1. The apparatus DS is applied to and mounted on a vehicle HV. The vehicle HV may be any of a vehicle having an internal combustion engine as a drive source, a vehicle having an electric motor as a drive source (i.e., an electric vehicle), or a hybrid vehicle.

In the present specification, an “ECU” means an electronic control device/unit that includes a microcomputer. The microcomputer includes a CPU (a processor), a ROM, a RAM, a writable non-volatile memory, and an interface. The ECU may also be referred to as a “controller” or a “computer”.

A driving support ECU 10 executes driving support control, which will be described later. The driving support ECU 10 is connected to the components described below and transmits and receives information or signals to and from them. The driving support ECU 10 may alternatively be implemented using a plurality of ECUs.

A camera sensor 21 acquires image data by capturing a surrounding scene, including a scene in front of the vehicle HV, at predetermined time intervals. The driving support ECU 10 acquires information indicating a positional relationship between the vehicle HV and an object present around the vehicle HV (i.e., positional relationship information), based on the image data. The objects present around the vehicle HV include a preceding vehicle traveling ahead of the vehicle HV, structures such as walls and fences, and a gate bar (i.e., a movable bar) installed at an entrance or exit of a parking area. The driving support ECU 10 can identify these objects based on the image data. Furthermore, the driving support ECU 10 can acquire an inclination angle (also referred to as a gradient) of a road surface located in front of the vehicle, in the longitudinal direction of the vehicle HV, based on the image data. The information obtained based on the image data acquired by the camera sensor 21 is referred to as “camera information”.

A radar sensor 22 is a well-known sensor configured to acquire information on objects located in front of the vehicle HV by using electromagnetic waves in the millimeter-wave band. The radar sensor 22 transmits millimeter-wave information regarding transmitted and received millimeter waves to the driving support ECU 10. The driving support ECU 10 acquires “radar information” based on the millimeter-wave information. The radar information includes, for example, a distance to an object, a direction (also referred to as an azimuth angle) of the object, and a relative speed of the object.

The driving support ECU 10 fuses the camera information with the radar information to generate fusion information. The driving support ECU 10 performs “collision avoidance support control, travel path deviation prevention control, or the like”, which will be described later, as part of the driving support control, based on the fusion information.

A vehicle speed sensor 23 outputs a signal indicative of a speed (i.e., vehicle speed Vh) of the vehicle HV.

A yaw rate sensor 24 outputs a signal indicative of a yaw rate Yr of the vehicle HV.

A steering angle sensor 25 outputs a signal indicative of a steering angle Sa of the vehicle HV.

A torque sensor 26 outputs a signal indicative of a steering torque Tq that is input to an unillustrated steering shaft of an unillustrated steering wheel of the vehicle HV.

An inclination angle sensor 27 outputs a signal indicative of an inclination angle Gr of the road surface on which the vehicle HV is traveling in the longitudinal direction of the vehicle HV.

An acceleration pedal operation amount sensor 28 outputs a signal indicative of an operation amount AP of an unillustrated acceleration pedal of the vehicle HV.

A brake pedal operation amount sensor 29 outputs a signal indicative of an operation amount BP of an unillustrated brake pedal of the vehicle HV.

The driving support ECU 10 is further connected to a powertrain actuator 30, a brake actuator 40, a steering motor (i.e., steering actuator) 50, an alarm device 60, and a navigation ECU 70.

The powertrain actuator 30 adjusts a driving force of the vehicle HV by driving unillustrated drive devices including the driving source of the vehicle HV.

The brake actuator 40 adjusts a braking force applied to the vehicle HV by driving unillustrated brake devices of the vehicle HV.

Therefore, the driving support ECU 10 can perform “automatic braking (i.e., emergency automatic braking)” that automatically applies the braking force to the vehicle HV by driving the brake actuator 40.

The steering motor 50 applies a torque to an unillustrated steering mechanism of the vehicle HV so as to vary the steered angle of unillustrated steered wheels of the vehicle HV.

The alarm device 60 includes a display device and an alarm sound generating device. In response to an instruction from the driving support ECU 10, the alarm device 60 causes the display device to display a predetermined alarm and causes the alarm sound generating device to generate a predetermined alarm sound.

The navigation ECU 70 is connected to a GPS receiver 71 and a map information storage device 72. The navigation ECU 70 acquires a current position of the vehicle HV based on a GPS signal received by the GPS receiver 71. The navigation ECU 70 or the driving support ECU 10 can determine whether or not the vehicle HV is located in a multi-story parking lot having a plurality of parking-lot slopes, based on the current position and map information stored in the map information storage device 72.

### Outline of Operation

The apparatus DS determines whether the vehicle HV is located in a multi-story parking lot having a plurality of parking-lot slopes, based on the current position, map information, or the like. Hereinafter, a multi-story parking lot having a plurality of parking-lot slopes, each requiring a specific turning travel may be referred to as a “specific parking lot”. When the apparatus DS determines that the vehicle HV is located in the specific parking lot, the apparatus DS performs a first process and a second process, which will be described below.

### First Process

When the apparatus determines that the vehicle HV is highly likely to collide with an object, it performs the automatic braking (i.e., collision avoidance assistance operation to avoid collision between the vehicle HV and the object). Note, however, that the apparatus DS inhibits (i.e., does not perform) the automatic braking when the steering operation index value, indicative of a steering operation state such as the steering angle Sa or the steering angle changing rate dSa, satisfies a steering override condition.

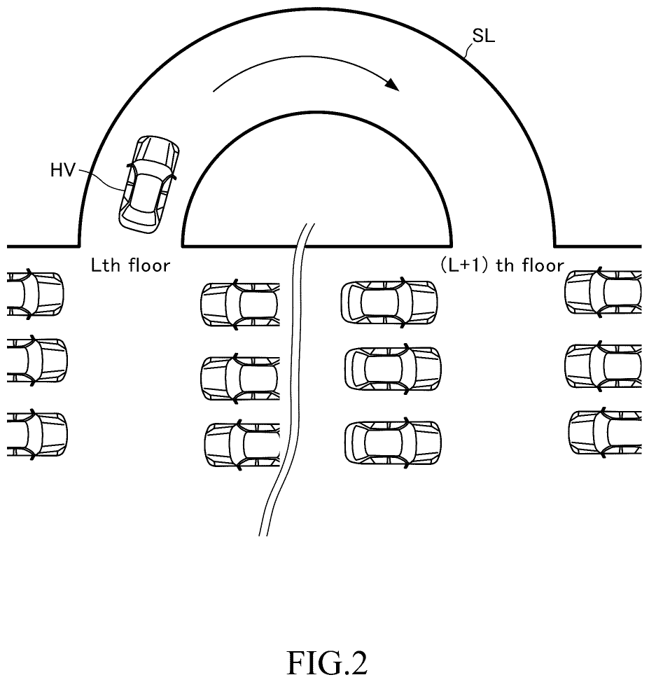

In the meantime, as shown in FIG. 2, since the parking-lot slope SL includes a curve with a large curvature, the driver is required to operate the steering wheel significantly and/or rapidly when passing through the parking-lot slope SL. Accordingly, the steering operation index value tends to easily satisfy the steering override condition, which may result in inhibition of the automatic braking. As a result, when the vehicle HV passes through the parking-lot slope SL, there is a relatively high likelihood that the vehicle HV will collide with an object such as a wall or a fence of the parking-lot slope SL.

In view of the above, when it is determined that the vehicle HV is located in the specific parking lot, the apparatus DS changes the steering override condition to a condition that is harder to be satisfied (or less likely to be satisfied) than the condition used when it is determined that the vehicle HV is not located in the specific parking lot. The process described above corresponds to the first process. As a result of executing the first process, the automatic braking can be performed as necessary while the vehicle HV is traveling through the parking-lot slope SL, because the steering override condition is less likely to be satisfied even if the driver significantly and/or rapidly operates the steering wheel. Accordingly, the possibility that the vehicle HV will collide with an object on the parking-lot slope SL can be reduced.

### Second Process

Furthermore, when the vehicle HV passes through the parking-lot slope for the first time after entering the specific parking lot, the apparatus DS acquires positional relationships between the vehicle HV and a wall and/or a fence of the parking-lot slope based on image data (or alternatively, the positional relationship information acquired based on the image data), and stores them as a reference travel path of the vehicle HV, thereby learning the travel path.

After learning the travel path of the vehicle HV, the apparatus DS compares the positional relationships with those in the learned reference travel path when the vehicle HV passes through another parking-lot slope of the same multi-story parking lot. When the apparatus DS determines that the vehicle HV has deviated from the reference travel path, it performs steering assistance by driving the steering motor 50 in such a manner that the vehicle HV comes closer to the reference travel path. That is, the apparatus DS performs the travel path deviation prevention control (i.e., a deviation suppression operation). This process to perform the steering assistance utilizing the learned travel path (i.e., the reference travel path) is the second process. The second process makes it possible to reduce, in advance, the likelihood that the vehicle HV will come into contact with an object in a parking-lot slope.

### Specific Operation

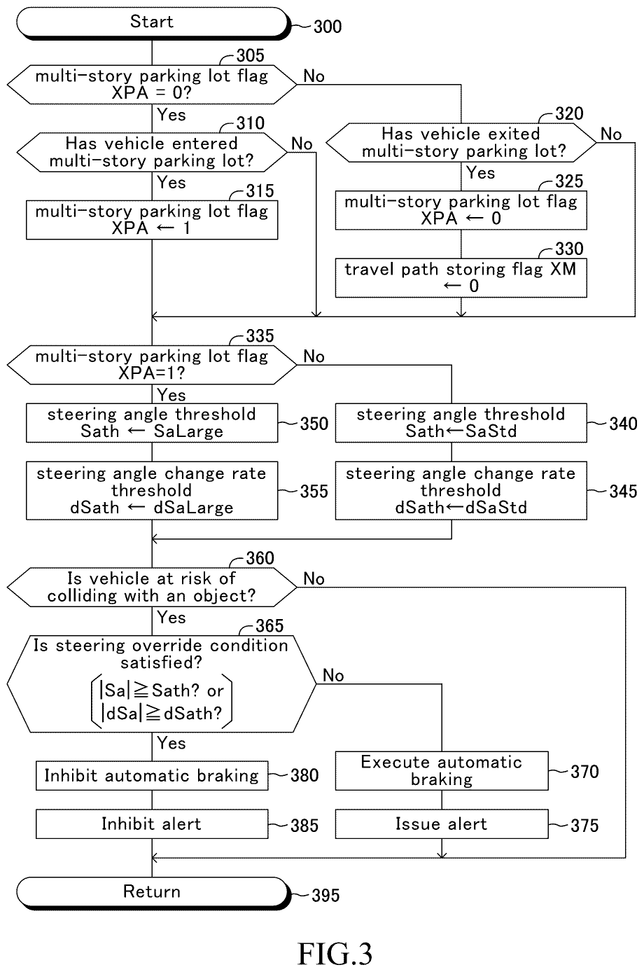

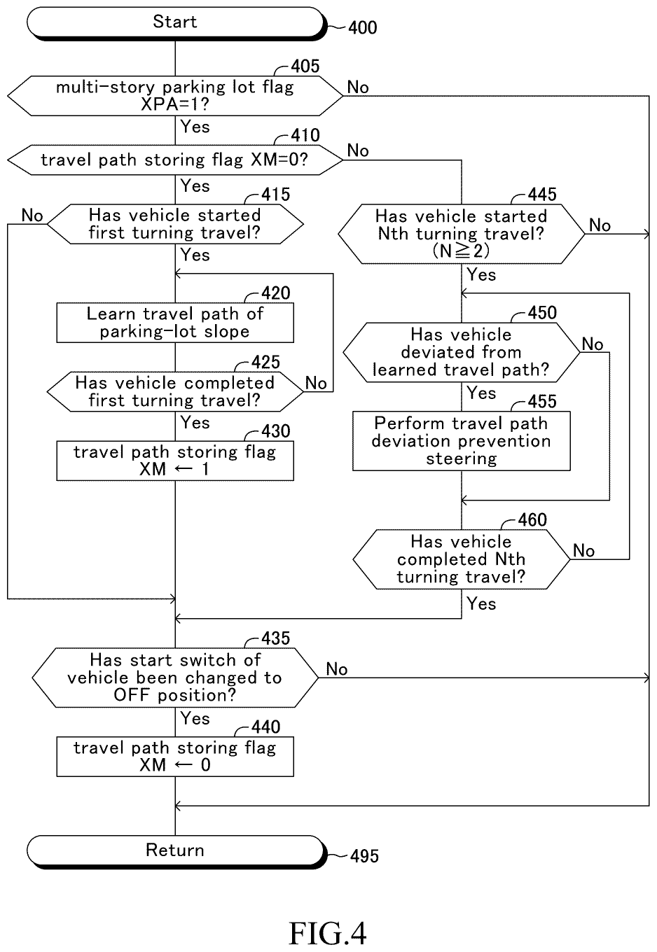

The CPU of the driving support ECU 10 executes the routines shown in FIGS. 3 and 4 at predetermined time intervals.

When an appropriate timing arrives, the CPU starts the routine from S300 shown in FIG. 3, and proceeds to S305. At S305, the CPU determines whether a value of a multi-story parking lot flag XPA is “0”.

When the value of the multi-story parking lot flag XPA is “0”, the CPU proceeds from S305 to S310, and determines whether or not the vehicle HV has entered a multi-story parking lot. Specifically, the CPU determines whether or not the vehicle HV has entered a multi-story parking lot based on “the current position and map information” acquired by the navigation ECU 70.

The CPU may determine that the vehicle HV has entered a multi-story parking lot when both Condition 1 and Condition 2 described below are satisfied.
(Condition 1) This is a condition to be satisfied when a movable bar at an entrance of a parking lot is recognized based on the image data.
(Condition 2) This is a condition to be satisfied when the inclination angle Gr of the road surface, detected by the inclination angle sensor 27, becomes equal to or larger than a predetermined inclination angle threshold Grth within a predetermined time period or before the vehicle HV travels a predetermined distance after the Condition 1 becomes satisfied. Note that the CPU may determine whether or not the inclination angle Gr of the road surface becomes equal to or greater than the predetermined inclination angle threshold Grth, based on the image data.

When the CPU determines that the vehicle HV has entered a multi-story parking lot, the CPU proceeds from S310 to S315. At S315, the CPU sets the value of the multi-story parking lot flag XPA to “1”. The value of the multi-story parking lot flag XPA is stored in the nonvolatile memory. Thereafter, the CPU proceeds to S335 from S315. On the other hand, when the vehicle HV has not entered a multi-story parking lot, the CPU directly proceeds to S335 from S310.

If the value of the multi-story parking lot flag XPA is “1” when the CPU reaches S305, the CPU proceeds from S305 to S320. At S320, the CPU determines whether or not the vehicle HV has exited the multi-story parking lot. Specifically, the CPU determines whether the vehicle HV has exited the multi-story parking lot, based on “the current position and map information” acquired by the navigation ECU 70.

When the CPU determines that the vehicle HV has exited the multi-story parking lot, the CPU proceeds from S320 to S325 so as to set the value of the multi-story parking lot flag XPA to “0”. Subsequently, the CPU proceeds to S330 so as to set a value of a travel path storing flag XM to “0”, and then, proceeds to S335. Whereas, if the CPU determines that the vehicle HV has not exited the multi-story parking lot, the CPU directly proceeds to S335 from S320.

In this manner, the value of the multi-story parking lot flag XPA is maintained at “1” in a period from the time point at which the vehicle HV enters the multi-story parking lot to the time point at which the vehicle HV exits the multi-story parking lot.

At S335, the CPU determines whether or not the value of the multi-story parking lot flag XPA is “1”. When the value of the multi-story parking lot flag XPA is not equal to “1”, the CPU proceeds to S340 from S335 so as to set a steering angle threshold Sath to a standard steering angle threshold SaStd. It should be noted that, as described later, when a magnitude (|Sa|) of the steering angle Sa is equal to or greater than the steering angle threshold Sath, a steering override condition is satisfied, leading to a stoppage (or an inhibition) of the automatic braking (refer to S365, S380).

Subsequently, the CPU proceeds to S345 from S340 so as to set a steering angle change rate threshold dSath to a standard steering angle change rate threshold dSaStd. It should be noted that, as described later, when a magnitude (|dSa|) of the steering angle change rate is equal to or greater than the steering angle change rate threshold dSath, the steering override condition is satisfied, leading to a stoppage (or an inhibition) of the automatic braking (refer to S365, S380). The CPU calculates a change amount in the steering angle Sa per unit time as the steering angle change rate dSa. Thereafter, the CPU proceeds to S360 from S345.

In contrast, if the value of the multi-story parking lot flag XPA is equal to “1” when the CPU proceeds to S335, the CPU proceeds from S355 to S350 so as to set the steering angle threshold Sath to a large steering angle threshold SaLarge. The large steering angle threshold SaLarge is greater than the standard steering angle threshold SaStd. Accordingly, while the vehicle HV is located in the multi-story parking lot, the steering override condition based on the steering angle Sa becomes harder to be satisfied (i.e., is less likely to be met) as compared to when the vehicle HV is not located in the multi-story parking lot.

Next, the CPU proceeds from S350 to S355 so as to set the steering angle change rate threshold dSath to a large steering angle change rate threshold dSaLarge. The large steering angle change rate threshold dSaLarge is greater than the standard steering angle change rate threshold dSaStd. Accordingly, while the vehicle HV is located in the multi-story parking lot, the steering override condition based on the steering angle change rate dSa becomes harder to be satisfied (i.e., is less likely to be met) as compared to when the vehicle HV is not located in the multi-story parking lot. Thereafter, the CPU proceeds from S355 to S360. The processes at S350 and S355 correspond to the above-described first process.

At S360, the CPU determines whether or not the vehicle HV is at risk of colliding with an object (i.e., an obstacle) by a well-known method. In other words, the CPU determines whether or not a collision determination condition, defined to be satisfied when there is a high likelihood that the vehicle HV will collide with an object around the vehicle HV, is met. For example, the CPU calculates a time to collision TTC that indicates a time remaining until the vehicle collides with an object in its traveling direction. The CPU determines that there is a high likelihood that the vehicle HV will collide with an object if the time to collision TTC is equal to or less than a time threshold TTCth. Here, the object may include not only another vehicle but also “walls, fences, and the like” of a parking-lot slope in a multi-story parking lot. The time to collision TTC is obtained by dividing a distance between the vehicle HV and the object by a relative speed between the object and the vehicle HV. It may be determined that there is a high likelihood that the vehicle HV will collide with the object when the vehicle speed Vh is equal to or lower than a low speed threshold Vhloth and a distance D between the vehicle HV and the object located in the traveling direction of the vehicle HV is equal to or less than a distance threshold Dth.

When the CPU determines that there is not a high likelihood that the vehicle HV will collide with an object, the CPU proceeds from S360 to S395 so as to terminate the present routine temporarily.

In contrast, when the CPU determines that there is a high likelihood that the vehicle HV will collide with an object, the CPU proceeds from S360 to S365 so as to determine whether or not the steering override condition is satisfied. That is, the CPU makes a steering override determination. The steering override condition is satisfied when at least one of Condition 3 and Condition 4 described below is satisfied.
(Condition 3) This is a condition to be satisfied when a magnitude (|Sa|) of the steering angle Sa is equal to or greater than the steering angle threshold Sath.
(Condition 4) This is a condition to be satisfied when a magnitude (|dSa|) of the steering angle change rate dSa is equal to or greater than the steering angle change rate threshold dSath.

When the steering override condition is not satisfied, the CPU proceeds from S365 to S370 so as to perform the automatic braking for avoiding a collision between the vehicle HV and the object. Subsequently, the CPU proceeds to S375 so as to cause the alarm device 60 to display the alarm and generate the alarm sound. Thereafter, the CPU proceeds to S395 so as to terminate the present routine temporarily.

Whereas, when the steering override condition is satisfied, the CPU proceeds from S365 to S380 so as to inhibit the automatic braking. That is, even when it is determined that there is a high likelihood that the vehicle HV will collide with the object at S360, the automatic braking is not performed. Subsequently, the CPU proceeds to S385 so as to inhibit the alarm. Thereafter, the CPU proceeds to S395 so as to terminate the present routine temporarily.

When an appropriate timing arrives, the CPU starts the routine from S400 shown in FIG. 4, and proceeds to S405. At S405, the CPU determines whether the value of the multi-story parking lot flag XPA is “1”. When the value of the multi-story parking lot flag XPA is equal to “0”, the CPU directly proceeds from S405 to S495 so as to terminate the present routine temporarily.

Whereas, when the value of the multi-story parking lot flag XPA is equal to “1”, the CPU proceeds from S405 to S410 so as to determine whether the value of the travel path storing flag XM is “0”. The value of the travel path storing flag XM is set to “0” when the vehicle HV exits the multi-story parking lot as described above (see S330), and is also set to “0” when a start switch of the vehicle HV is changed to an OFF position (see S440).

Accordingly, if the current time point is immediately after the vehicle HV has entered the multi-story parking lot after being started, the value of the travel path storing flag XM is “0”. In this case, the CPU proceeds from S410 to S415 so as to determine whether or not the vehicle HV has started the first turning travel of the parking-lot slope. A parking-lot slope associated with this first turning travel is also referred to as a “first slope”.

The first turning travel of the parking-lot slope refers to travel of the vehicle HV through the parking-lot slope connecting a current floor on which the vehicle HV is traveling to an immediately upper floor when the value of the travel path storing flag XM is “0”. Alternatively, the first turning travel of the parking-lot slope refers to travel of the vehicle HV through the parking-lot slope connecting a floor (an Mth floor) on which the vehicle HV is parked (i.e., when the start switch is changed from the ON position to the OFF position) to an immediately lower floor (an (M−1)th floor).

Specifically, the CPU determines whether the vehicle HV has started the first turning travel of the parking-lot slope by determining whether a magnitude (|Yr|) of a yaw rate Yr has changed, after the vehicle HV has entered the multi-story parking lot, from being less than a yaw rate threshold Yrth to being equal to or greater than the yaw rate threshold Yrth for the first time. When the vehicle HV has not started the first turning travel of the parking-lot slope, the CPU proceeds from S415 to S435.

Whereas, when the vehicle HV has started the first turning travel of the parking-lot slope, the CPU proceeds from S415 to S420 so as to learn and store the travel path of the parking-lot slope as described above. The learning result is stored in the nonvolatile memory.

Subsequently, the CPU proceeds to S425 so as to determine whether the vehicle HV has completed the first turning travel of the parking-lot slope. Specifically, the CPU determines whether the vehicle HV has completed the first turning travel of the parking-lot slope by determining whether the magnitude (|Yr|) of the yaw rate Yr has changed, after determining that the vehicle HV has started the first turning travel of the parking-lot slope, from being equal to or greater than the yaw rate threshold Yrth to being less than the yaw rate threshold Yrth for the first time.

When the vehicle HV has not completed the first turning travel of the parking-lot slope, the CPU returns from S425 to S420 so as to continue learning the travel path of the parking-lot slope.

When the vehicle HV has completed the first turning travel of the parking-lot slope, the CPU proceeds from S425 to S430 so as to set the value of the travel path storing flag XM to “1”.

Thereafter, the CPU proceeds from S430 to S435 so as to determine whether the start switch of the vehicle HV has been changed from the ON position to the OFF position, and thus, the operation of the vehicle HV is ended. If the start switch of the vehicle HV has not been changed from the ON position to the OFF position, the CPU proceeds from S435 to S495 so as to terminate the present routine temporarily.

Whereas, when the start switch of the vehicle HV has been changed from the ON position to the OFF position so that the operation of the vehicle HV is ended, the CPU proceeds from S435 to S449 so as to set the value of the travel path storing flag XM to “0”. Thereafter, the CPU proceeds to S495.

When the CPU starts executing the routine shown in FIG. 4 again in a case where the learning of the travel path of the parking-lot slope has been completed so that the value of the travel path storing flag XM is set to “1” while the start switch is not changed to the OFF position, the CPU proceeds from S405 to S410, and makes a “No” determination at S410 so as to proceed to S445.

At S445, the CPU determines whether the vehicle HV has started Nth (N is an integer equal to or larger than 2) turning travel of the parking-lot slope. A parking-lot slope associated with this Nth turning travel is also referred to as a “second slope”. The Nth turning travel of the parking-lot slope refers to travel of the vehicle HV through the parking-lot slope connecting an Nth floor to an immediately upper floor (an (N+1)th floor). Alternatively, in a case where the vehicle HV is parked on an Mth floor (i.e., when the start switch is changed to the OFF position), the Nth turning travel of the parking-lot slope refers to travel of the vehicle HV through the parking-lot slope connecting an (L−1)th floor to an immediately lower floor ((L−2)th floor), wherein L is any integer equal to or smaller than M.

Specifically, the CPU determines whether the vehicle HV has started the Nth turning travel of the parking-lot slope by determining whether the magnitude (|Yr|) of the yaw rate Yr has changed from being less than the yaw rate threshold Yrth to being equal to or greater than the yaw rate threshold Yrth. When the vehicle HV has not started the Nth turning travel of the parking-lot slope, the CPU directly proceeds from S445 to S495.

Whereas, when the vehicle HV has started the Nth turning travel of the parking-lot slope, the CPU proceeds from S445 to S450 so as to determine whether the vehicle HV has deviated from the travel path learned at S420 (i.e., the reference travel path). Specifically, the CPU determines, based on the image data, whether a predetermined deviation condition, which is defined to be satisfied when the travel path of the vehicle HV deviates from the learned travel path, is met.

The CPU determines that the vehicle HV has deviated from the learned travel path, for example, when a distance Dmin between the vehicle HV and a specific object closest to the vehicle HV is equal to or less than a% (e.g., 70%) of a distance Dmem between the vehicle HV and the specific object when the vehicle HV travels on the learned path (i.e., Dmin≤α·Dmem/100).

When the CPU determines that the vehicle HV has deviated from the learned travel path, the CPU proceeds from S450 to S455 so as to perform travel path deviation prevention control (i.e., a deviation suppression operation to reduce a degree of deviation from the reference travel path of the vehicle HV). Specifically, the CPU changes the steered angle of the steered wheels by driving the steering motor 50 in such a manner that the position of the vehicle HV comes closer to the reference travel path.

Subsequently, the CPU proceeds to S460 so as to determine whether the vehicle HV has completed the Nth turning travel of the parking-lot slope. Specifically, the CPU determines whether the vehicle HV has completed the Nth turning travel of the parking-lot slope by determining whether the magnitude (|Yr|) of the yaw rate Yr has changed from being equal to or greater than the yaw rate threshold Yrth to being less than the yaw rate threshold Yrth.

When the vehicle HV has not completed the Nth turning travel of the parking-lot slope, the CPU returns from S460 to S450. Consequently, because the travel path deviation prevention control is performed when the vehicle HV deviates from the learned travel path at S455, the vehicle HV can travel through the parking-lot slope along the learned travel path.

When the vehicle HV has completed the Nth turning travel of the parking-lot slope, the CPU proceeds from S460 to S435.

It should be noted that, when the vehicle HV is parked in the multi-story parking lot, the start switch of the vehicle HV is switched to the OFF position. Therefore, the CPU sets the value of the travel path storing flag XM to “0” as a result of the processes of S435 and S440. Accordingly, the CPU performs learning of the parking-lot slope again (refer to S410 to S430). In other words, if the vehicle HV is parked in the multi-story parking lot, the travel path that has been learned is cleared, and learning of the travel path for descending is performed.

As has been described, when the apparatus DS determines that the vehicle HV is located in the specific parking lot, the apparatus DS executes the first process to change the steering override condition to a condition that is less likely to be satisfied (or is harder to be satisfied) than when the apparatus DS determines that the vehicle HV is not located in the specific parking lot. Accordingly, because the apparatus DS can increase a likelihood of executing the automatic braking on the parking-lot slope, the likelihood that the vehicle HV will come into contact with an object on the parking-lot slope can be reduced.

Furthermore, the apparatus DS learns a positional relationship between the vehicle HV and walls and/or fences of the parking-lot slope as the reference travel path in the first slope. When the apparatus DS determines that the predetermined deviation condition, which is defined to be satisfied when the actual travel path of the vehicle HV has deviated from the reference travel path, is met (S450: Yes) in the second slope, the apparatus DS executes the second process to perform the deviation suppression operation for reducing the degree of deviation of the vehicle HV from the reference travel path (S455). Thus, the apparatus DS can reduce the possibility that the vehicle HV will come into contact with an object on the parking-lot slope.

It should be noted that the present disclosure is not limited to the above-described embodiment, and various modifications as described below may be adopted within the scope of the present disclosure. For example, the present disclosure may be applied to an autonomous vehicle when a driving mode has been switched from the autonomous driving mode to the manual driving mode by a driver.

In the above embodiment, the CPU determines that the specific condition is satisfied when the vehicle HV is located in the specific parking lot, and switches the steering override condition to the condition that is harder to be satisfied. However, the CPU may determine that the specific condition is satisfied when the vehicle HV is located in the specific parking lot and when a turning condition becomes satisfied. The turning condition may be a condition that is defined to be satisfied when a magnitude of the steering angle Sa is equal to or greater than a predetermined value, or may be a condition that is defined to be satisfied when a traveling path is determined to be a curved path based on the image data. Furthermore, the apparatus DS may include a plurality of cameras, a LiDAR, and a plurality of sonars, and may determine, based on information from at least one of these, whether the collision determination condition is satisfied, or may perform the learning of the reference travel path and the deviation determination from the reference travel path.

What is claimed is:

1. A driving support apparatus comprising a controller configured to:
execute a collision avoidance operation to prevent a collision between a vehicle and an object when a collision determination condition, which is defined to be satisfied when there is a high likelihood that said vehicle will collide with said object, is met; and
not execute said collision avoidance operation even when said collision determination condition is met if a steering override condition, which is defined to be satisfied when a driver of said vehicle performs a predetermined steering operation, is met,
wherein,
said controller is configured to switch said steering override condition to a condition that is harder to be satisfied when a specific condition is satisfied than when said specific condition is not satisfied, said specific condition including a condition defined to be satisfied when said vehicle is located in a specific parking lot having a plurality of slopes each requiring a predetermined turning travel to pass through.

2. The driving support apparatus according to claim 1,
wherein said specific parking lot is a multi-story parking lot.

3. The driving support apparatus according to claim 1 further comprising a camera configured to acquire image data by capturing a scene around said vehicle,
wherein,
said controller is configured to:
store, as a reference travel path, a travel path of said vehicle acquired based on said image data in a first slope that is one of said plurality of slopes when said vehicle passes through said first slope; and
execute a deviation suppression operation to reduce a degree of deviation of said vehicle from said reference travel path when determining, based on said image data, that a predetermined deviation condition, which is defined to be satisfied when a travel path of said vehicle has deviated from said reference travel path, is satisfied while said vehicle is traveling in a second slope that is another of said plurality of slopes.

4. The driving support apparatus according to claim 1,
wherein
said steering override condition is defined to be satisfied when a magnitude of a steering angle is greater than a steering angle threshold; and
said controller is configured to switch said steering angle threshold to a greater value when said specific condition is satisfied than when said specific condition is not satisfied, whereby said steering override condition becomes harder to be satisfied when said specific condition is satisfied.

5. The driving support apparatus according to claim 1,
wherein
said steering override condition is defined to be satisfied when a magnitude of a steering angle change rate is greater than a steering angle change rate threshold; and
said controller is configured to switch said steering angle change rate threshold to a greater value when said specific condition is satisfied than when said specific condition is not satisfied, whereby said steering override condition becomes harder to be satisfied when said specific condition is satisfied.

6. A driving support method comprising:
a step of executing a collision avoidance operation to prevent a collision between a vehicle and an object when a collision determination condition, which is defined to be satisfied when there is a high likelihood that said vehicle will collide with said object, is met; and
a step of inhibiting said collision avoidance operation even when said collision determination condition is met if a steering override condition, which is defined to be satisfied when a driver of said vehicle performs a predetermined steering operation, is met; and
a step of switching said steering override condition to a condition that is harder to be satisfied when a specific condition is satisfied than when said specific condition is not satisfied, said specific condition including a condition defined to be satisfied when said vehicle is located in a specific parking lot having a plurality of slopes each requiring a predetermined turning travel to pass through.

7. A non-transitory storage medium storing a program, said program causing a computer to implement:
a step of executing a collision avoidance operation to prevent a collision between a vehicle and an object when a collision determination condition, which is defined to be satisfied when there is a high likelihood that said vehicle will collide with said object, is met; and
a step of inhibiting said collision avoidance operation even when said collision determination condition is met if a steering override condition, which is defined to be satisfied when a driver of said vehicle performs a predetermined steering operation, is met; and
a step of switching said steering override condition to a condition that is harder to be satisfied when a specific condition is satisfied than when said specific condition is not satisfied,
wherein said specific condition includes a condition defined to be satisfied when said vehicle is located in a specific parking lot having a plurality of slopes each requiring a predetermined turning travel to pass through.
